(19) United States
(12) Patent Application Publication
(10) Pub. No.: US 2024/0049878 A1
(43) Pub. Date: Feb. 15, 2024

(54) PARTS ORGANIZER

(71) Applicant: TECHTRONIC CORDLESS GP, Anderson, SC (US)

(72) Inventors: John D. Parsons, Greenville, SC (US); Charles E. Key, III, Six Mile, SC (US)

(21) Appl. No.: 17/819,565

(22) Filed: Aug. 12, 2022

(51) Int. Cl. A47B 88/60; A47B 88/975

(52) U.S. Cl. CPC A47B 88/60; A47B 88/975

(57) ABSTRACT

A storage system includes a housing including a compartment defined by compartment sidewalls and a compartment rear wall. The housing further includes a first closure structure adjacent or on the compartment rear wall. The storage system further includes a bin positionable in the compartment and pivotable relative to the housing between a closed position and an open position. The bin includes bin sidewalls and a bin rear wall at least partially defining a storage space accessible from outside the housing in the open position, and the bin rear wall has a second closure structure. The first closure structure and the second closure structure cooperatively define a closure detent that resists pivotal movement of the bin from the closed position to the open position absent a predetermined force acting on the bin toward the open position.

### TECHNICAL FIELD

The present disclosure relates to storage systems, and more particularly to small parts organizers or the like.

### BACKGROUND

In conventional systems, parts organizers include a housing including compartments and bins disposed within the compartments. The bins may be movable within the compartments between an open and a closed position.

### SUMMARY

In one independent aspect, a storage system includes a housing including a compartment defined by compartment sidewalls and a compartment rear wall. The housing further includes a first closure structure adjacent or on the compartment rear wall. The storage system further includes a bin positionable in the compartment and pivotable relative to the housing between a closed position and an open position. The bin includes bin sidewalls and a bin rear wall at least partially defining a storage space accessible from outside the housing in the open position, and the bin rear wall has a second closure structure. The first closure structure and the second closure structure cooperatively define a closure detent that resists pivotal movement of the bin from the closed position to the open position absent a predetermined force acting on the bin toward the open position.

In another independent aspect, a storage system includes a housing including a compartment having a front opening and defined by compartment sidewalls, a compartment rear wall, and a compartment bottom wall. The housing further includes a compartment ledge projecting into the compartment and extending along a first of the compartment sidewalls. The storage system further includes a bin positionable in the compartment and movable relative to the housing between a closed position and an open position. The bin includes bin sidewalls, a bin rear wall, and a bin bottom wall cooperatively at least partially defining a storage space accessible from outside the housing in the open position. The bin further includes a bin ledge projecting outward from a first of the bin sidewalls. The bin ledge is engageable with the compartment ledge in the open position to inhibit further movement of the bin relative to the housing.

In yet another independent aspect, a storage system includes a housing including a compartment having a front opening and defined by compartment sidewalls, a compartment rear wall, and a compartment bottom wall. The housing further includes pivot posts extending inward from the compartment sidewalls and spaced from the bottom wall. The storage system further includes a bin positionable in the compartment and pivotal relative to the housing between a closed position and an open position. The bin includes bin sidewalls, a bin rear wall, and a bin bottom wall cooperatively at least partially defining a storage space accessible from outside the housing in the open position. The bin further includes pivot pockets disposed adjacent and spaced from the bin bottom wall, and the pivot pockets are engageable by the pivot posts. In the open position, the bin is configured to be lifted upward relative to the compartment bottom wall and then forward relative to the compartment rear wall to remove the bin from the housing.

Other features and aspects of the disclosure will become apparent by consideration of the detailed description and accompanying drawings.

### BRIEF DESCRIPTION OF THE DRAWINGS

FIG. 1A is a perspective view of a parts organizer.

FIG. 1B is a perspective view of the parts organizer of FIG. 1A with a bin in an open position.

FIG. 2A is a perspective view of a housing of the parts organizer of FIG. 1A.

FIG. 2B is another perspective view of the housing of FIG. 2A.

FIG. 3A is an enlarged perspective view of portion 3-3 of the housing of FIG. 2A.

FIG. 3B is an enlarged perspective view of FIG. 3A showing a pivot post for the bins.

FIG. 4 is a perspective view of portion 4-4 of the housing of FIG. 2A.

FIG. 5A is a perspective view of a small bin of the parts organizer of FIG. 1A.

FIG. 5B is another perspective view of the small bin of FIG. 5A.

FIG. 6 is a perspective view of a large bin of the parts organizer of FIG. 1A.

FIG. 7A is a cross-section view of the parts organizer taken along section line 7a-7a in FIG. 1A.

FIG. 7B is a cross-section view of the parts organizer taken along section line 7b-7b in FIG. 1B.

FIG. 8 is a cross-section view of the parts organizer taken along section line 8-8 of FIG. 1A.

FIG. 9A is another perspective view of the small bin of FIG. 5A illustrating a removable front panel.

FIG. 9B is a rear perspective view of the front panel of FIG. 9A.

FIG. 9C is a rear perspective view of a front panel of the large bin of FIG. 6.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

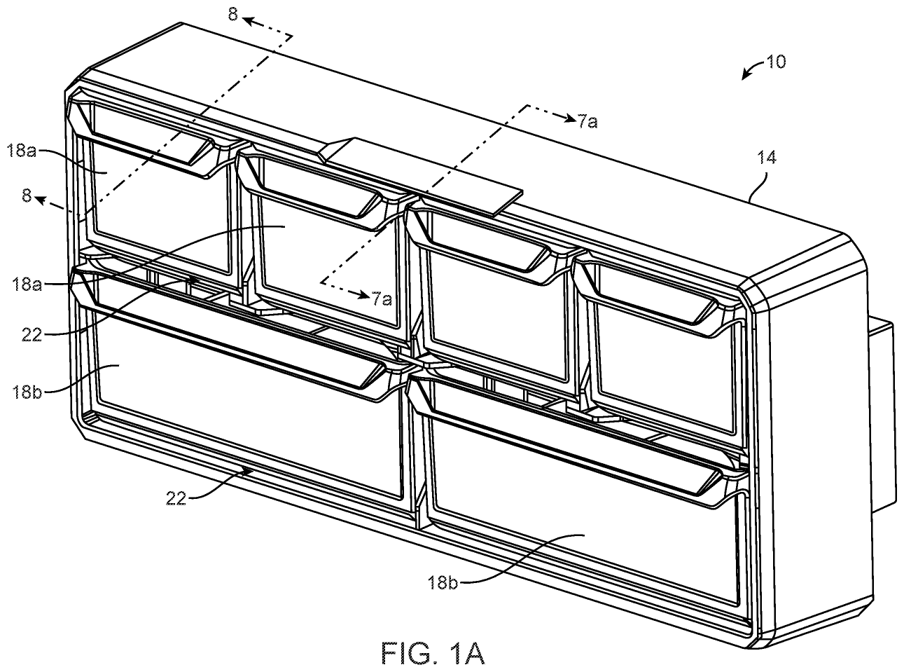

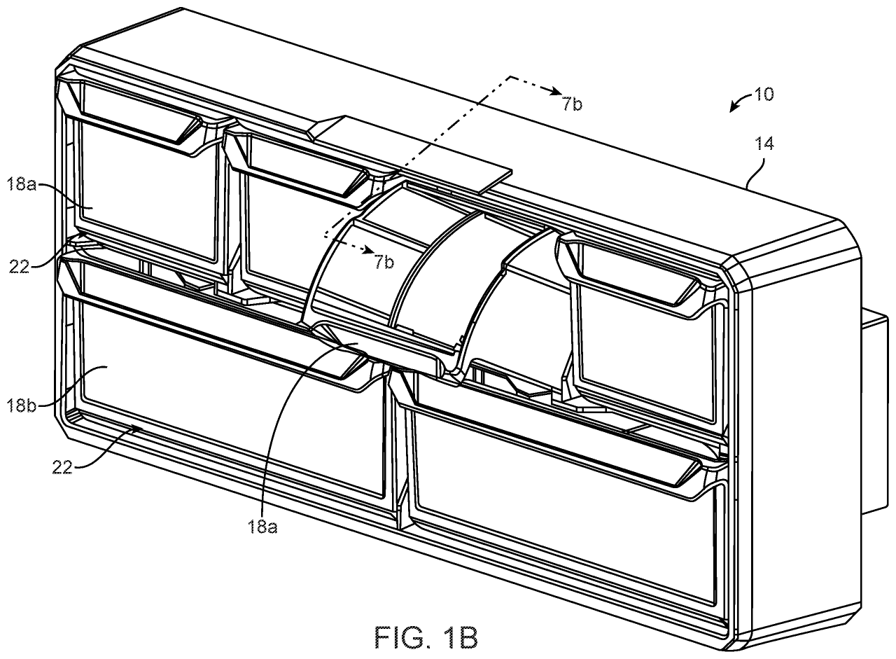

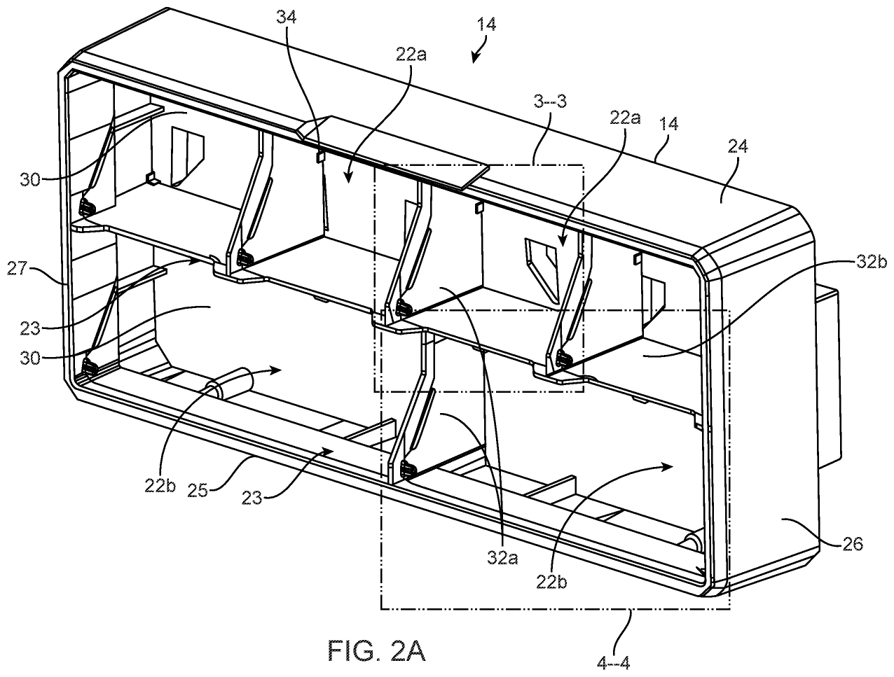

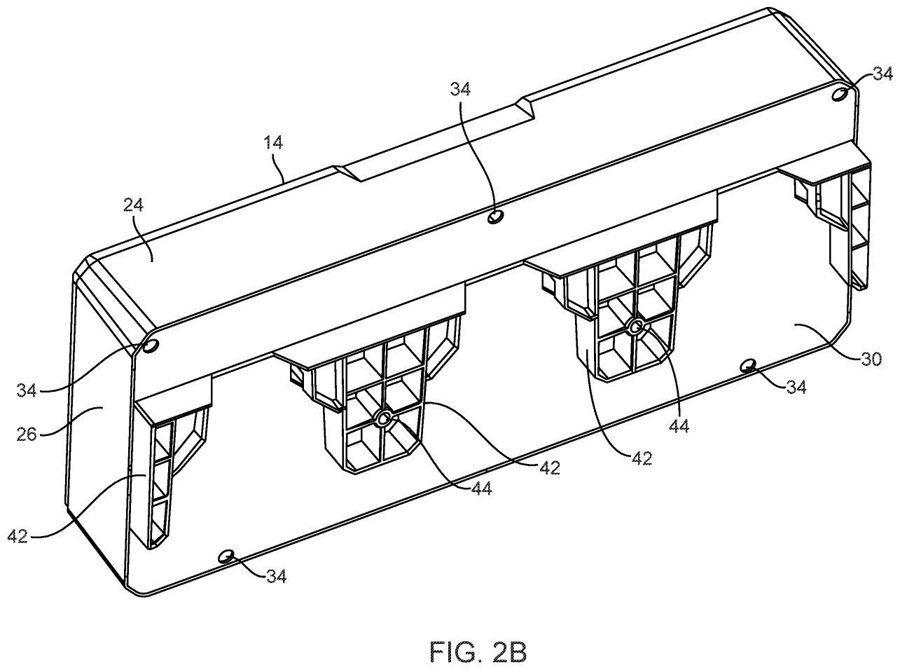

FIGS. 1A-2B illustrate an exemplary parts organizer 10 including a housing 14 and bins 18 (e.g., small bins 18a, large bins 18b) that are supported in compartments 22 (e.g., small compartments 22a, large compartments 22b) of the housing 14. The compartments 22 have front openings 23 within which the bins 18a, 18b can be coupled to the housing 14 for storage of components (e.g., fasteners, etc.) in storage spaces 24 defined by the bins 18a, 18b. In the illustrated embodiment, the housing 14 supports four small bins 18a in a top row of the small compartments 22a, and two large bins 18b in a bottom row of the large compartments 22b. It should be appreciated that the quantity of bins 18, including the quantity of small bins 18a and large bins 18b, supported by the housing 14 may vary from what is shown without deviating from the invention. With reference to FIG. 1B, each bin 18a, 18b is movable or pivotable relative to the housing 14 between an open or accessible position and a closed or inaccessible position.

With reference to FIG. 2A, the housing 14 includes a top wall 24, a bottom wall 25, a first sidewall 26, a second sidewall 27, a back wall 30, and one or more vertical divider walls 32a that cooperatively define the spaces in which the bins 18 are supported. As shown, the housing 14 further includes a horizontal divider wall 32b that vertically separates the compartments 22a, 22b from each other and assists with defining the compartments 22a, 22b. It will be appreciated that the quantity of divider walls 32a, 32b may vary and generally correspond to the quantity of bins 18 that are supported by the housing 14 As shown, the divider walls 32a, 32b are formed integrally with the top wall 24, bottom wall 25, first sidewall 26, and second sidewall 27, although the divider walls 32a, 32b may be separate components that are coupled to one or more of the walls 24, 25, 26, 27. As best illustrated in FIG. 2B the back wall 30 is a separate component that is attached to the remainder of the housing 14 by fasteners (not shown) that extend through holes 34 in the back wall 30 and into the housing 14. In some embodiments, the back wall 30 may be integrally formed with the remainder of the housing 14.

With reference to FIG. 2B, the housing 14 further includes projections 42 that extend from the back wall 30. The illustrated projections 42 have a generally Y-shape and engage spaces between cleats of a storage structure (not shown) for mounting the housing 14 to a wall or other structures. As shown, the central projections 42 also have fastener holes 38 to provide another attachment mechanism for the housing 14 to a structure.

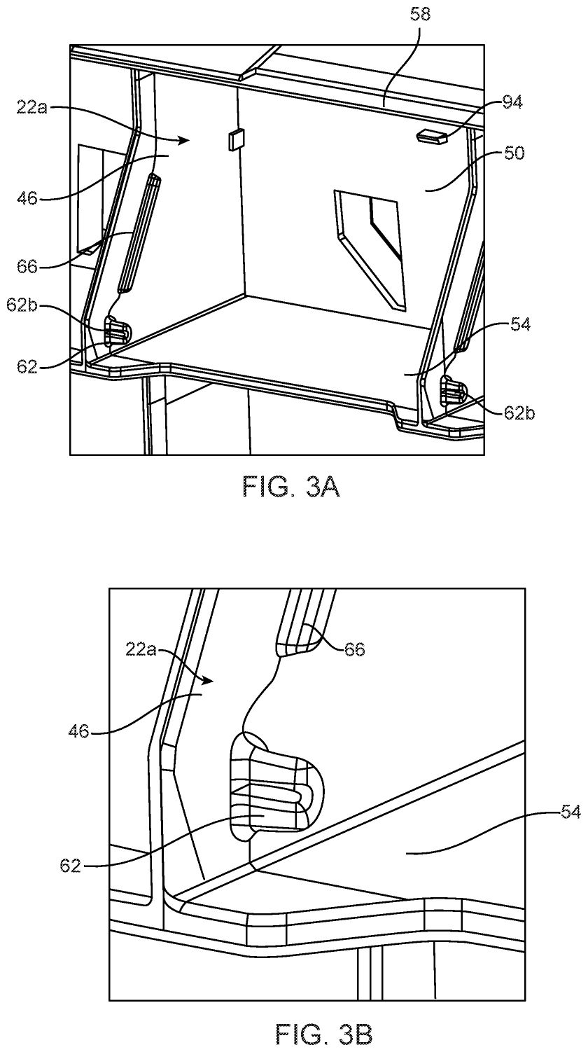

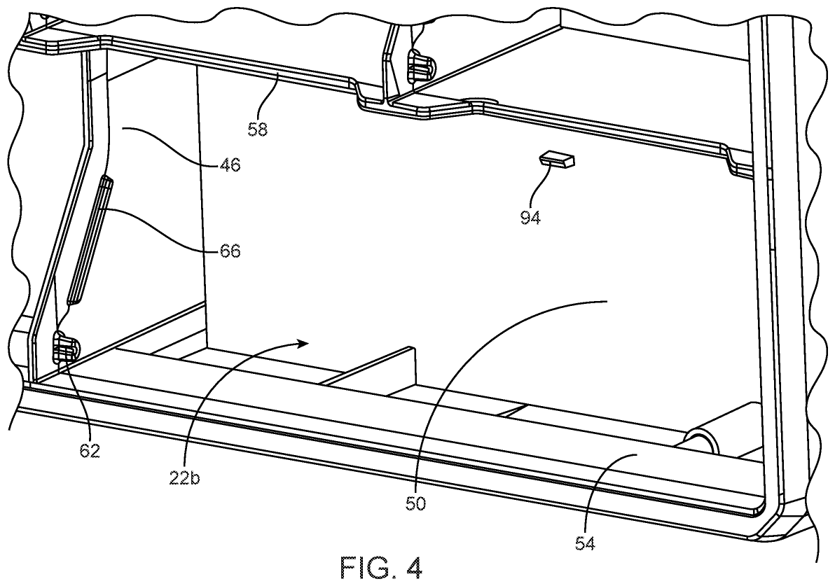

Referring to FIGS. 3A and 4, each compartment 22a, 22b is defined by two compartment sidewalls 46, a compartment rear wall 50, a compartment bottom wall 54, and a compartment top wall 58. Depending on the location of the compartment 22a, 22b, each compartment sidewall 46 is defined by the first sidewall 26, the second sidewall 27, or a divider wall 32a. Each compartment rear wall 50 is defined by the back wall 30, and the compartment bottom wall 54 is defined by the bottom wall 25 or the divider wall 32b. The compartment top wall 58 is defined by the top wall 24 or the divider 32b. As best shown in FIGS. 3A-4, each compartment sidewall 46 has a pivot post 62 that is adjacent and spaced as small distance from the compartment bottom wall 54. With reference to FIG. 3B, each pivot post 62 is defined by a half-cylinder projection with the curved portion facing toward the compartment rear wall 50, and the flat portion facing away from the compartment rear wall 50. In the illustrated embodiment, each compartment sidewall 46 also includes a compartment ledge 66 that extends upward and rearward adjacent the front opening 23 (e.g., parallel to an edge of the front opening 23). In some embodiments, only one of the compartment sidewalls 46 may have the compartment ledge 66. The compartment bottom wall 54 defines a first plane, and the compartment ledge 66 is elongated along a second plane that is oriented at an oblique angle relative to the first plane.

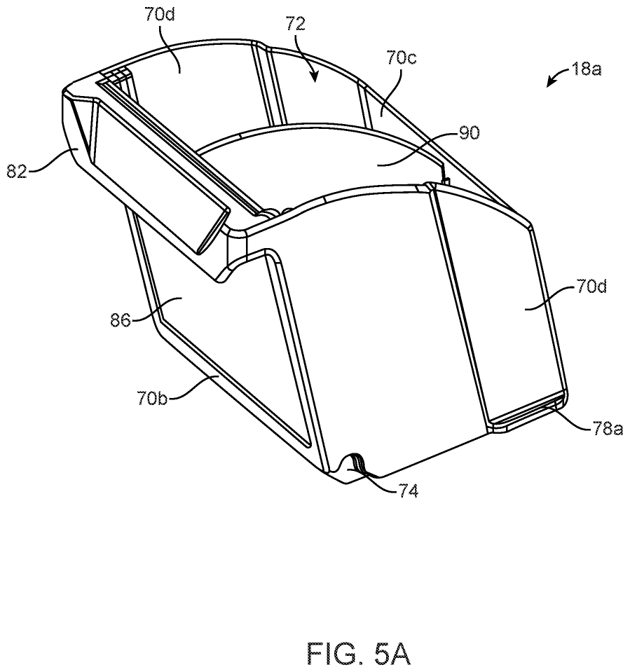

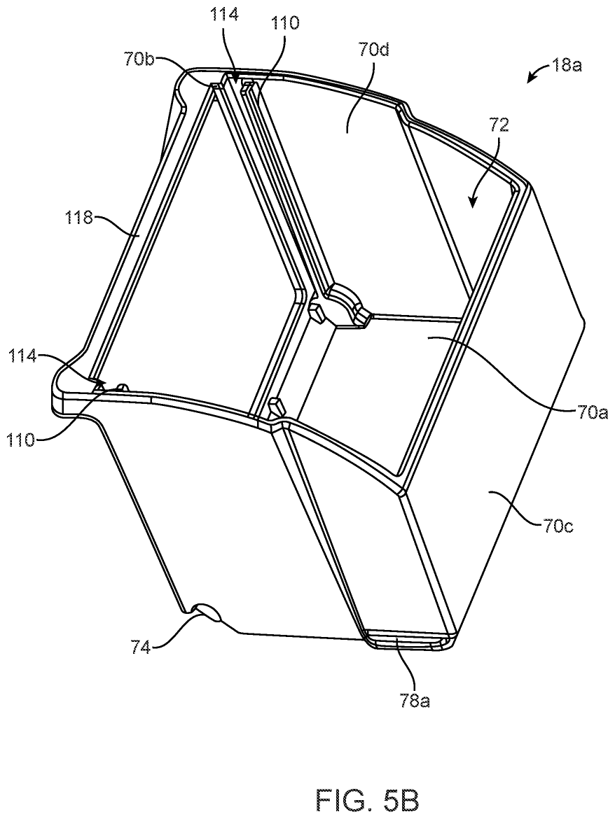

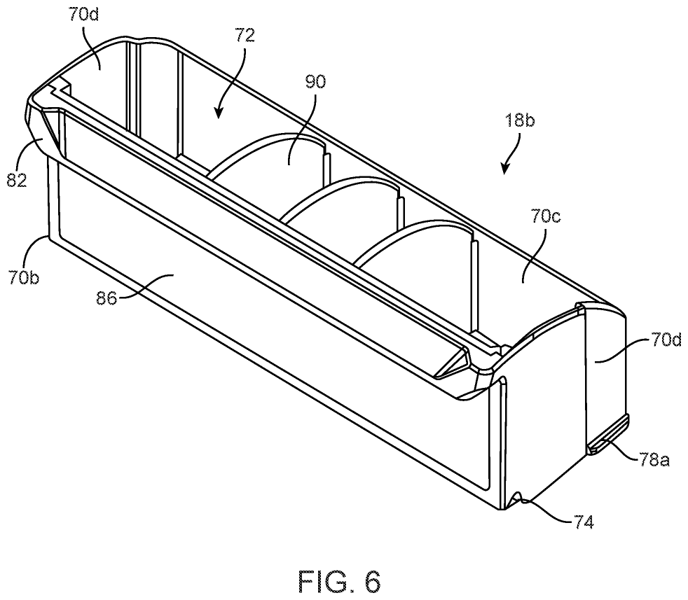

With reference to FIGS. 5A, 5B, and 6, each bin 18a, 18b is defined by a bin bottom wall 70a, a bin front wall 70b, a bin rear wall 70c, and two bin sidewalls 70d that define a storage space 72. In the illustrated embodiment, each bin 18a, 18b includes pivot pockets 74 that are defined in each bin sidewall 70d adjacent to the bin bottom wall 70a and the bin front wall 70b. The pivot pockets 74 are positionable on the pivot posts 62 such that each bin 18a, 18b can pivot relative to the housing 14 between the open position and the closed position. In the illustrated embodiment, each pivot pocket 74 is open toward the bin bottom wall 70a such that the pivot pockets 74 only partially surround the pivot posts 62 to allow removal of the bin 18 from the corresponding pivot posts 62 in a generally upward direction. With reference to FIGS. 5A7B, each bin 18a, 18b further includes a first bin ledge 78a that projects outward from a first of the bin sidewalls 70d adjacent the bin bottom wall 70a and a second bin ledge 78b that projects outward from a second of the bin sidewalls 70d adjacent the bin bottom wall 70a. Each bin ledge 78a, 78b is further located adjacent to the rear wall 70c (e.g., the bin ledges 78a, 78b are closer to the rear wall 70c than to the front wall 70b). In some embodiments, each bin 18a, 18b may include only one bin ledge 78.

With continued reference to FIGS. 5A and 6, each bin 18 further includes a grip or handle 82 that extends from the bin front wall 70b. In the illustrated embodiment, the handle 82 is integrally formed with the bin front wall 70b and can be grasped by a user to aid in pivoting the bin 18 between the open position and the closed position. FIGS. 5A, 5B, 6, and 9A-9C show that each bin 18 further includes a front panel 86 that may be removably coupled to the bin front wall 70b. In the illustrated embodiment, one or more of the bins 18 may include one or more bin dividers 90 to divide the bin 18 into sections. In some embodiments, the bin 18 may include two or more bin dividers 90.

With reference to FIG. 5B, the bin sidewalls 70d have a rail 110 that extends vertically adjacent the bin front wall 70b and that cooperates with the bin front wall 70b to define a groove 114 in which the front panel 86 can be positioned. The bin front wall 70b includes a portion 118 that may flex relative to the bin 18 to facilitate installation of the front panel 86. The portion 118 abuts the front panel 86 when the front panel 86 is coupled to the bin 18.

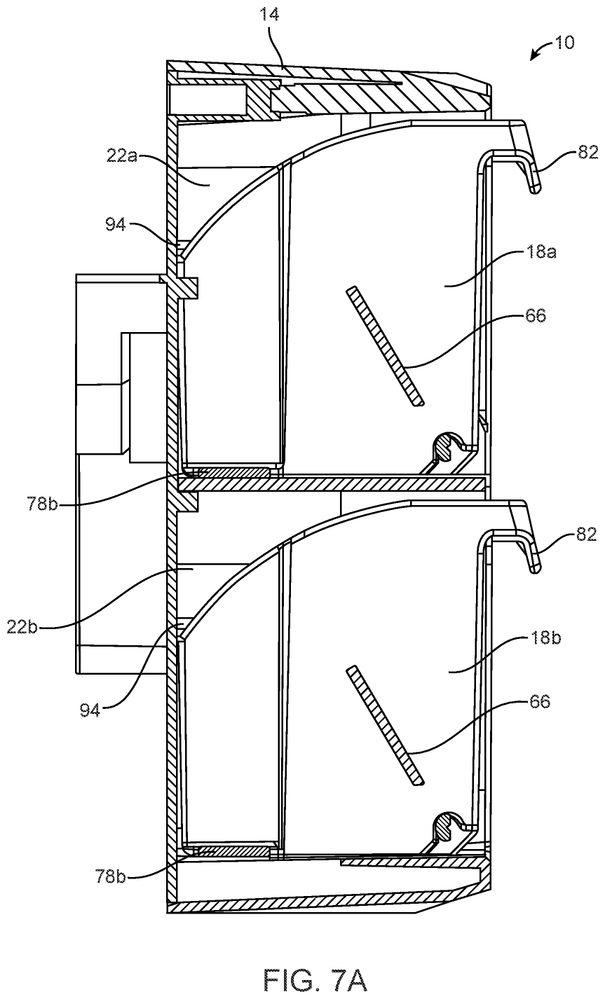

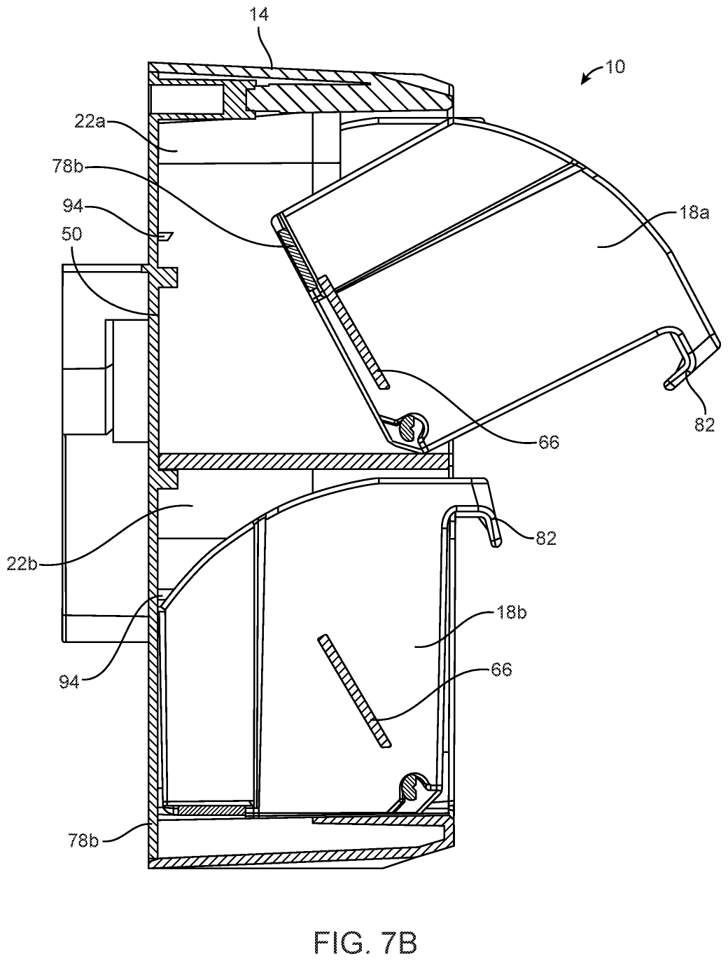

Referring to FIGS. 7A and 7B, the bin ledges 78a, 78b are engageable with the corresponding compartment ledge 66 in the open position to inhibit movement of the bin 18 beyond the open position (i.e. removed from the housing 14). As shown in FIG. 7B, when the bin 18 is pivoted to the open position, the bin ledge 78 is substantially parallel or parallel to the compartment ledge 66.

With continued reference to FIG. 7B, each bin 18a, 18b is removable from its compartment 22a, 22b. To remove one of the bins 18a, 18b from the housing 14, the bin 18a, 18b is first pivoted to the open position. The bin 18a, 18b is then lifted upward relative to the housing 14 to disengage the pivot posts 62 from the pivot pockets 74. Upward movement also moves the bin ledges 78 out of engagement with the compartment ledges 66 so that the bin 18a, 18b can then be pulled through the front opening 23 without interference. As such, a user can remove and replace a bin 18a, 18b or utilize a bin 18a, 18b without the rest of the parts organizer 10.

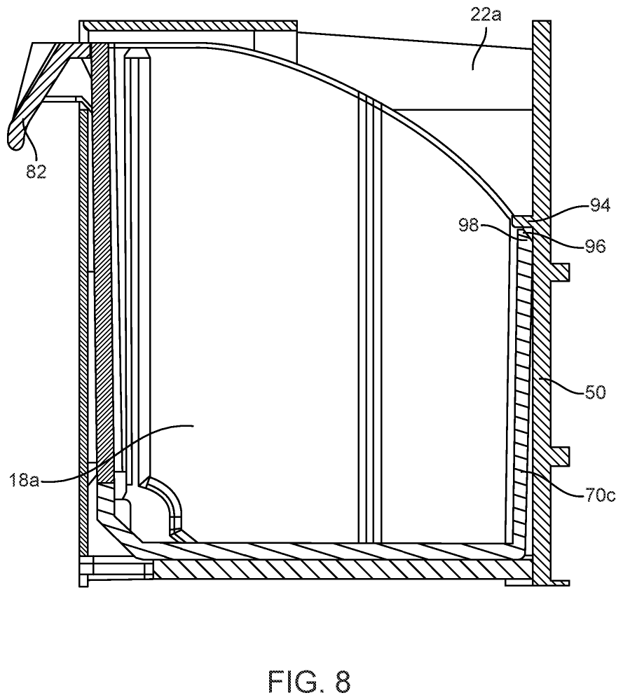

With reference to FIGS. 3A, 4, 7B, and 8, each compartment 22a, 22b includes a first closure structure 94. In the illustrated embodiment, the first closure structure 94 is a protrusion that projects from the compartment rear wall 50 into the compartment 22a, 22b. As shown, at least a portion of the first closure structure 94 is wedge-shaped with an angled surface 96 that faces into the compartment 22. Each bin 18a, 18b includes a second closure structure 98 that is defined by an upper edge of the bin rear wall 70c. As shown, the upper edge or closure structure 98 is curved. When the bin 18a, 18b is in the closed position, the first closure structure 94 engages the second closure structure 98 (e.g., frictional engagement or snap engagement) such that the first closure structure 94 and the second closure structure 98 cooperatively define a closure detent for the bin 18a, 18b to hold the bin 18a, 18b in the closed position absent a force pulling the bin 18a, 18b toward the open position. A relatively light, predetermined force must be applied to the bin 18a, 18b to overcome engagement of the first closure structure 94 and the second closure structure 98 to pivot from the closed position to the open position. In other words, the closure detent resists pivotal movement of the bin 18a, 18b from the closed position to the open position absent a predetermined force acting on the bin 18a, 18b toward the open position. In some embodiments, the bin 18 may include the first closure structure 94 and the housing 14 may include the second closure structure 98.

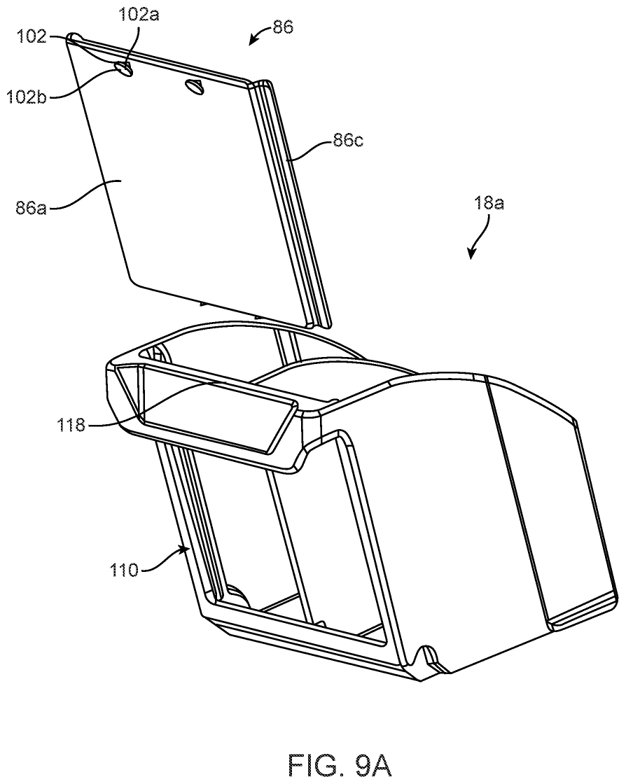

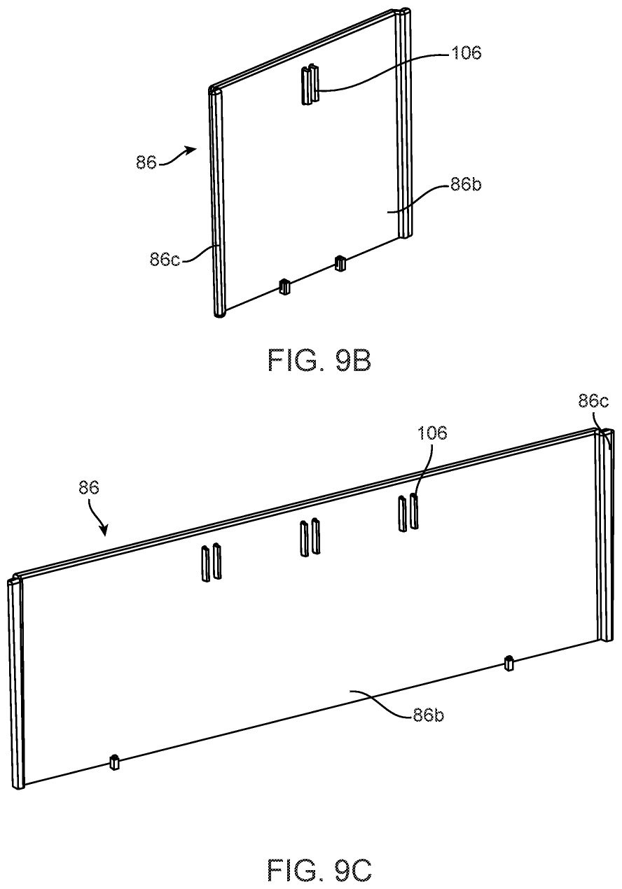

Referring to FIGS. 9A-9C, the illustrated front panel 86 of each bin 18a, 18b is removable from the bin 18a, 18b and may be transparent so that contents in the bin 18a, 18b may be viewed from outside the housing 14. As illustrated in FIG. 9A, the front panel 86 includes one or more wedge-shaped projections 102 on a front surface 86a of the front panel 86 (two projections 102 are shown by way of example. The projections 102 are defined by a ledge 102a and an angled surface 102b. Due to the configuration of the projections 102, the front panel 86 couples to the front wall 86 (e.g., the portion 118) in a snap-fit manner that resists removal of the front panel 86 from the bin 18. As illustrated in FIG. 9B, the front panel 86 also includes a pair of ribs 106 on a rear surface 86b of the front panel 86 to receive and align the bin divider 90 in the bin 18 when the bin divider 90 is desired. As illustrated in FIG. 9C, the front panel 86 of the large bins 18b may include two or more pairs of ribs 106 for respective optional dividers 90.

Referring to FIGS. 9A-9C, the front panel 86 further includes side edges 86c that engage and are slidable along the grooves 114 of the bin 18a, 18b. To attach the front panel 86 to the bin 18a, 18b, the side edges 86c of the front panel 86 are inserted into the grooves 114 and then slid toward the bin bottom wall 70a until the projections 102 of the front panel 86 engage the portion 118 of the bin front wall 70b. Due to angled nature of the side surfaces of the projections 102, the projections 102 may slightly deform the portion 118 of the bin front wall 70b until the projections 102 pass the portion 118. When the front panel 86 is fully attached to the bin 18a, 18b, the top surface of the projection 102 abuts the portion 118. To remove front panel 86 from the bin 18a, 18b, a user slightly bends the portion 118 (e.g., by pulling on the handle 82 or directly pressing the portion 118) so that the top surfaces of the projections 102 can clear the bin front wall 70b.

Although aspects have been described in detail with reference to certain embodiments, variations and modifications exist within the scope of one or more independent aspects as described.

What is claimed is:

1. A storage system comprising:
a housing including a compartment defined by compartment sidewalls and a compartment rear wall, the housing further including a first closure structure adjacent or on the compartment rear wall; and
a bin positionable in the compartment and pivotable relative to the housing between a closed position and an open position, the bin including bin sidewalls and a bin rear wall at least partially defining a storage space accessible from outside the housing in the open position, the bin rear wall having a second closure structure,
wherein the first closure structure and the second closure structure cooperatively define a closure detent that resists pivotal movement of the bin from the closed position to the open position absent a predetermined force acting on the bin toward the open position.

2. The storage system of claim 1, wherein the first closure structure includes a protrusion extending from the compartment rear wall into the compartment and the second closure structure is defined by an upper edge of the bin rear wall.

3. The storage system of claim 2, wherein the protrusion of the first closure structure is at least partially wedge-shaped.

4. The storage system of claim 1, wherein the bin further includes a bin front wall and a front panel that is selectively couplable to the bin front wall.

5. The storage system of claim 4, wherein a front surface of the front panel includes a projection that is engageable with a flexible portion of the bin front wall to couple the front panel to the bin in a snap-fit manner.

6. The storage system of claim 4, wherein the front panel further includes a rear surface having two ribs that define a channel for receiving a bin divider.

7. The storage system of claim 1, wherein the housing includes a back wall having one or more attachment surfaces projecting from the back portion and configured to couple the back portion to another structure.

8. A storage system comprising:
a housing including a compartment having a front opening and defined by compartment sidewalls, a compartment rear wall, and a compartment bottom wall, the housing further including a compartment ledge projecting into the compartment and extending along a first of the compartment sidewalls; and
a bin positionable in the compartment and movable relative to the housing between a closed position and an open position, the bin including bin sidewalls, a bin rear wall, and a bin bottom wall cooperatively at least partially defining a storage space accessible from outside the housing in the open position, the bin further including a bin ledge projecting outward from a first of the bin sidewalls,
wherein the bin ledge is engageable with the compartment ledge in the open position to inhibit further movement of the bin relative to the housing.

9. The storage system of claim 8, wherein the compartment ledge projects into the compartment and extends along a first of the compartment sidewalls upward relative to the compartment bottom wall and rearward relative to the front opening.

10. The storage system of claim 8, wherein the compartment bottom wall defines a first plane and the compartment ledge defines a second plane oriented at an oblique angle relative to the first plane.

11. The storage system of claim 8, wherein the bin ledge extends parallel to the bin bottom wall.

12. The storage system of claim 11, wherein the bin is pivotal from the closed position to the open position, and the bin ledge is engageable with the compartment ledge in the open position to inhibit further pivotal movement of the bin relative to the housing.

13. The storage system of claim 12, wherein the housing further includes pivot posts extending inward from the compartment sidewalls, the bin includes pivot pockets within the bin sidewalls, the pivot pockets engageable by the pivot posts such that the bin is pivotable relative to the housing.

14. The storage system of claim 13, wherein the pivot pockets include an open portion facing toward the bin bottom wall, and wherein, when the bin is in the open position, the bin can be lifted upward relative to the housing, to disengage the pivot posts from the pivot pockets and disengage the bin ledge from the compartment ledge, and then forward relative to the compartment rear wall to remove the bin from the housing.

15. The storage system of claim 8, wherein the compartment includes a second compartment ledge projecting into the compartment and extending along a second of the compartment sidewalls, and the bin includes a second bin ledge projecting outward from a second of the bin sidewalls.

16. The storage system of claim 8, wherein when the bin ledge engages the compartment ledge in the open position, the bin ledge is approximately parallel to the compartment ledge.

17. A storage system comprising:
a housing including a compartment having a front opening and defined by compartment sidewalls, a compartment rear wall, and a compartment bottom wall, the housing further including pivot posts extending inward from the compartment sidewalls and spaced from the compartment bottom wall; and
a bin positionable in the compartment and pivotal relative to the housing between a closed position and an open position, the bin including bin sidewalls, a bin rear wall, and a bin bottom wall cooperatively at least partially defining a storage space accessible from outside the housing in the open position, the bin further including pivot pockets disposed adjacent and spaced from the bin bottom wall, the pivot pockets engageable by the pivot posts,
wherein, in the open position, the bin is configured to be lifted upward relative to the compartment bottom wall and then forward relative to the compartment rear wall to remove the bin from the housing.

18. The storage system of claim 17, wherein the pivot pockets include an open portion facing toward the bin bottom wall, and wherein, when the bin is lifted upward from the open position, the pivot pockets disengage the pivot posts.

19. The storage system of claim 18, wherein the compartment further includes a compartment ledge extending along a first of the compartment sidewalls, and the bin further includes a bin ledge extending along a first of the bin sidewalls, and wherein the bin ledge engages the compartment ledge when the bin is in the open position and disengages the compartment ledge when the bin is lifted upward relative to the compartment from the open position.

20. The storage system of claim 17, wherein the bin further includes a handle that is engageable by a user to pivot the bin between the open position and the closed position and remove the bin from the housing.
